(19) United States
(12) Patent Application Publication
(10) Pub. No.: US 2022/0071432 A1
(43) Pub. Date: Mar. 10, 2022

(54) Juicer with Handle

(71) Applicant: Progressive International Corporation, Kent, WA (US)

(72) Inventors: Joseph Kent, Seattle, WA (US); Sascha Kaposi, Tacoma, WA (US); Geoff Woo, Seattle, WA (US)

(73) Assignee: Progressive International Corporation, Kent, WA (US)

(21) Appl. No.: 17/468,407

(22) Filed: Sep. 7, 2021

Related U.S. Application Data
(60) Provisional application No. 63/074,567, filed on Sep. 4, 2020.

(51) Int. Cl. A47J 19/02

(52) U.S. Cl. CPC A47J 19/023

(57) ABSTRACT

A juicer includes a container with a spout and a central support pillar extending upwardly from a floor of the container. A strainer having a handle and a reamer is configured to be removably supported by the container and the central pillar. The strainer is mounted for rotation by grasping the handle and rotating the strainer with respect to the container so that juice expressed from a fruit will flow down the reamer to the strainer, with pulp being captured by the strainer while juice flows through the through-holes provided in the strainer and into the container.

### BACKGROUND OF THE INVENTION

A hand-operated juicer for squeezing juice from citrus fruits such as oranges can be a very useful tool. An example of a manual juicer is described in U.S. Pat. No. 2,487,371 to Quam. The '371 patent describes a juicer having a pedestal which supports a container so that the container can be rotated or pivoted atop the pedestal. This arrangement creates a separate pedestal piece which must be carefully positioned with respect to the container and the reamer. It further leads to a shallow collection container because of the nature of the interaction of the pedestal, container, and reamer.

### SUMMARY OF THE INVENTION

A hand-operated juicer for squeezing juice from citrus fruits such as oranges

### BRIEF DESCRIPTION OF THE DRAWINGS

The preferred embodiments of the invention are described below with reference to the following drawings.

FIG. 1 is a top perspective view of a preferred juicer with handle.

FIG. 2 is a front elevational view of a preferred juicer with handle.

FIG. 3 is a top perspective view of a preferred container for a juicer with handle.

FIG. 4 is an alternate top perspective view of a preferred container for a juicer with handle

FIG. 5 is a front elevational view of a preferred strainer for use with a juicer with handle.

FIG. 6 is a bottom plan view of a preferred strainer.

FIG. 7 is a bottom perspective view of the preferred strainer.

FIG. 8 is an exploded view of a central support and bearing for use with a preferred strainer.

FIG. 9 is a bottom perspective view of a preferred bearing for use with the preferred strainer.

### DETAILED DESCRIPTION OF THE PREFERRED EMBODIMENT

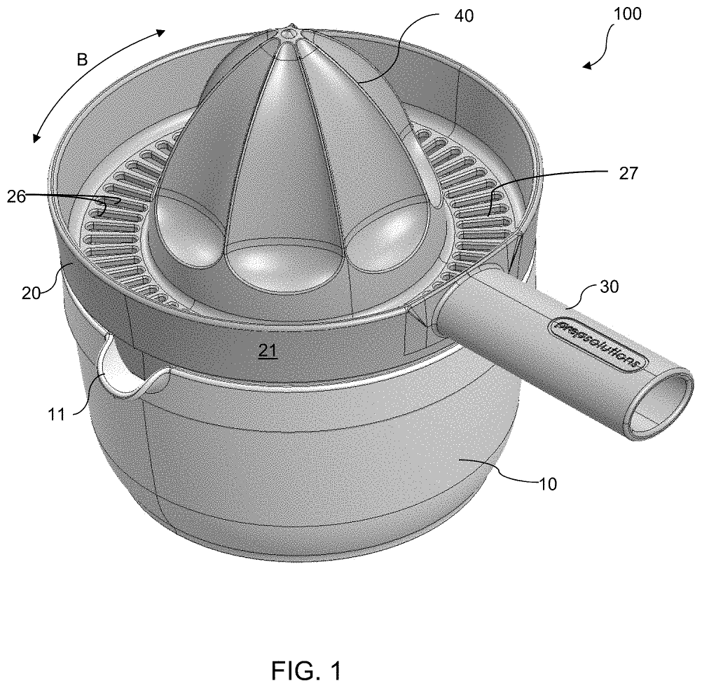

A preferred version of a juicer 100 is shown in the accompanying figures. FIG. 1 illustrates the juicer in a top perspective view, including a container 10, a strainer 20 with handle 30, and a reamer 40. The strainer includes a floor 27 having a plurality of through-holes 26, and a peripheral sidewall 21. The reamer 40 is positioned above the strainer so that juice expressed from the fruit will flow down the reamer to the strainer, with pulp being captured by the strainer while juice flows through the through-holes provided in the strainer. In the preferred version, the reamer, strainer, and handle are all integrally formed from a common material.

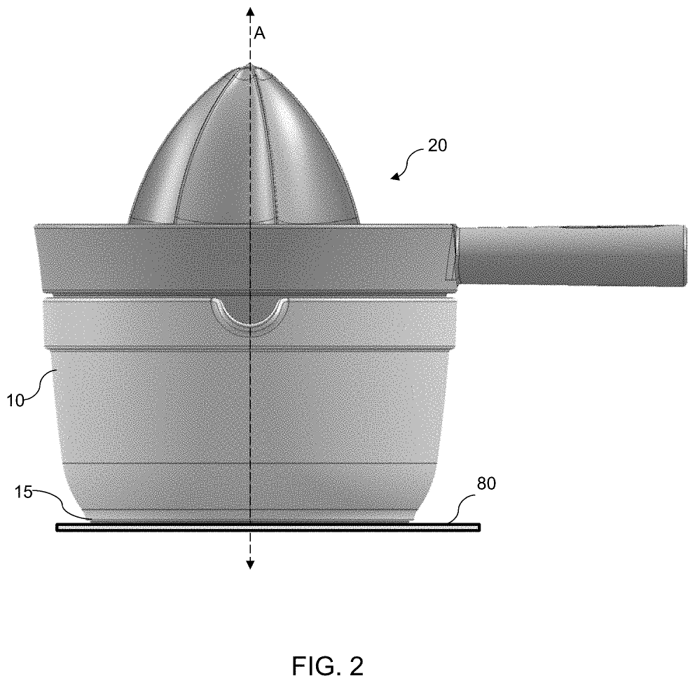

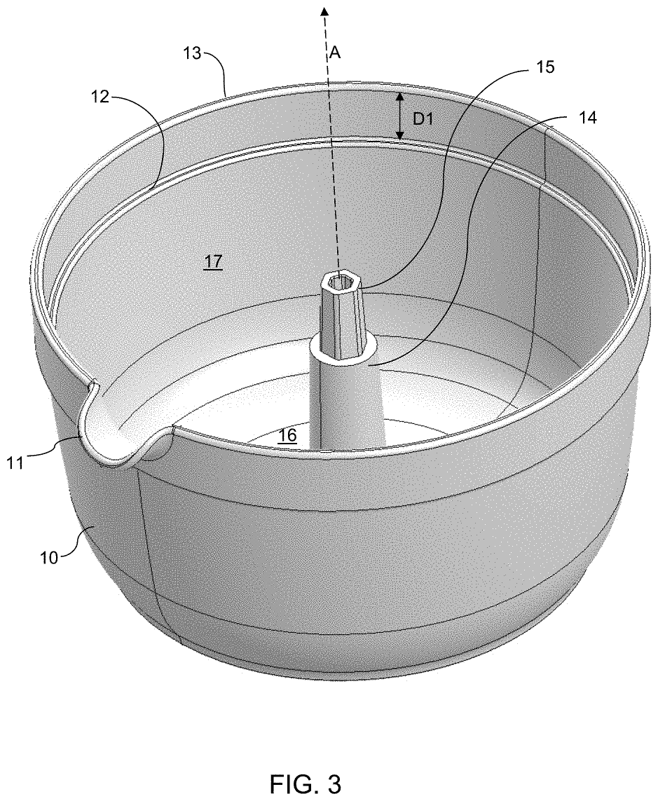

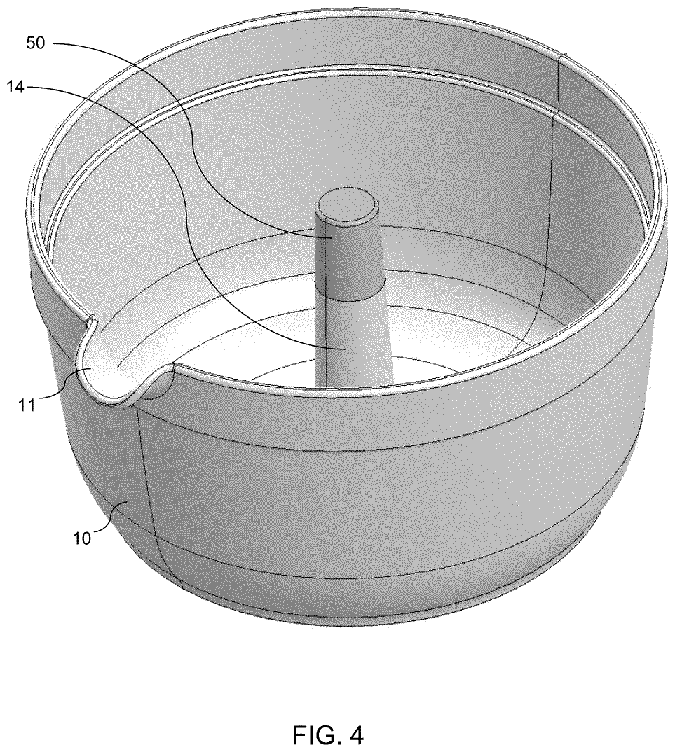

The container is fashioned as a bowl, and preferably includes a spout 11 such as seen in FIGS. 3 and 4 with the strainer removed. The strainer is removably seated atop the container to enable juice to be pressed from a fruit and captured by the container after passing through the strainer. As indicated in FIGS. 1 and 2, the strainer is sized and configured to allow for rotational movement of the strainer about a central axis A extending through the container and the strainer, and thereby along arc B (which is a segment of a circle having a center at axis A) with respect to the container. The bottom of the container may include an elastomeric ring 15 to provide a nonskid surface for aiding in retaining the container in a stationary position on a horizontal surface 80 such as a countertop.

FIG. 3 illustrates the container alone in a top perspective view. In this preferred example, the container includes a bottom 16 and an upwardly extending sidewall 17 terminating in a rim 13. The spout 11 is shown along a portion of the rim. Preferably, an interior shoulder 12 is positioned on an inner surface of the sidewall forming the container, spaced a distance D1 below the rim. A central pillar 14 extends upwardly from the container, along the central axis A, and is preferably integrally formed with the container. Most preferably, the central pillar extends upwardly from the bottom 16 of the container. An upper portion 15 of the central pillar is splined or formed with a non-circular cross-section, which in the preferred example is hexagonal.

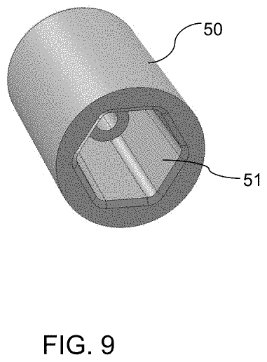

As seen in FIG. 4, a bearing 50 is positioned atop the central pillar. The bearing provides a seat for a portion of the strainer, as further discussed below. As illustrated in FIG. 9, an interior of the bearing is formed with a mating hexagonal or otherwise splined surface so that it may be attached to and surround the top portion of the central pillar and be retained against rotational movement with respect to the pillar.

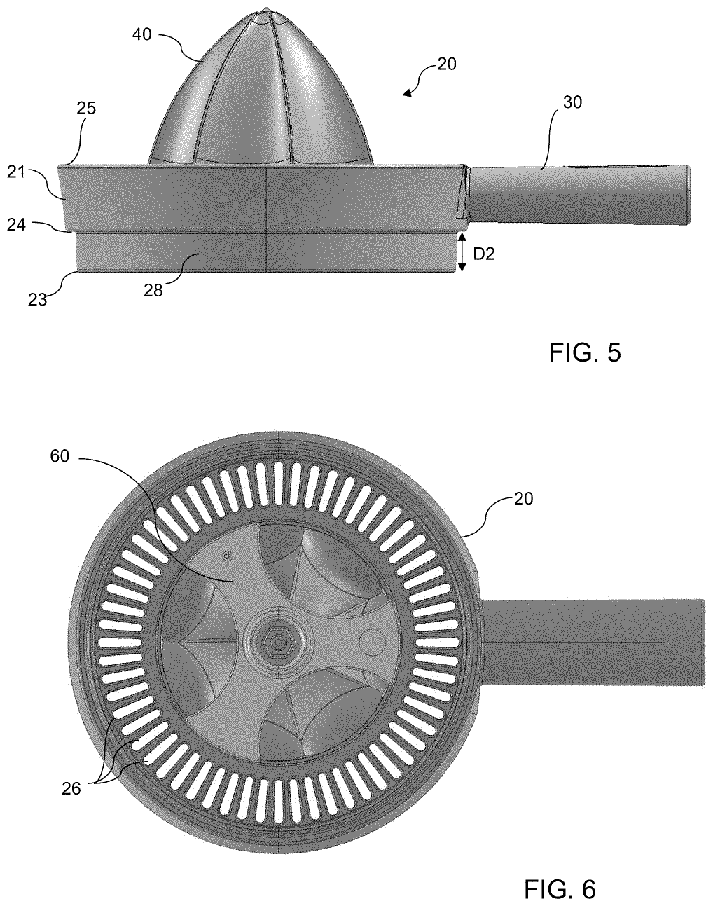

FIG. 5 illustrates the strainer in a front elevational view, while FIG. 6 illustrates the strainer in a bottom plan view. The preferred version of the strainer includes a peripheral strainer sidewall 21 extending upwardly from the floor of the strainer and terminating in a strainer rim 25. A lower skirt 28 extends downwardly, away from the sidewall. Most preferably, the skirt is recessed inwardly from the upper peripheral sidewall 21 between a lower edge 23 to define an upper abutment 24, and extends below the abutment for a distance D2. In this configuration, the skirt is sized and configured to sit within the container such that the lower abutment 23 of the skirt sits on or rests slightly above the interior shoulder 12 of the container, while the upper abutment 24 of the strainer sits upon or rests slightly above the upper rim 13 of the container.

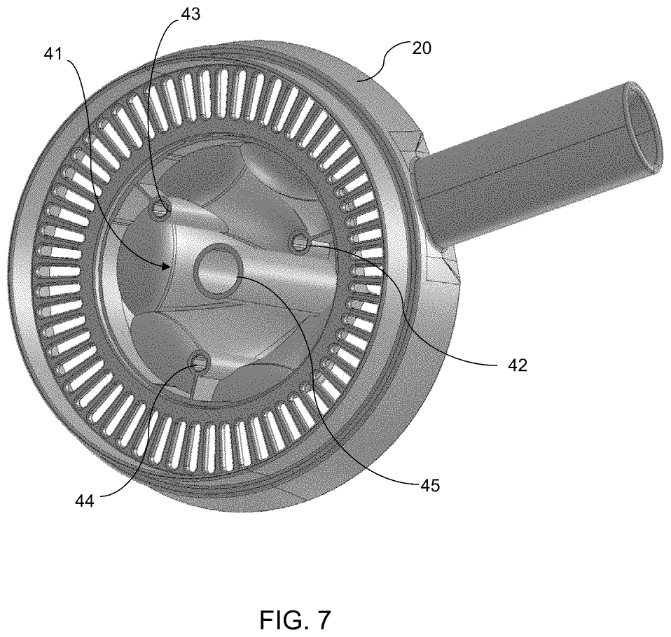

FIG. 6 illustrates a bottom plan view of a preferred strainer, including a central support 60. The central support is removed in the bottom perspective view of FIG. 7, showing attachment locations for the strainer to connect with the central support. In the illustrated example, the lower side of the strainer (visible in FIG. 7) includes a cavity 41 within the reamer configured with a plurality of peripheral barrels 42, 43, 44 and a central barrel 45.

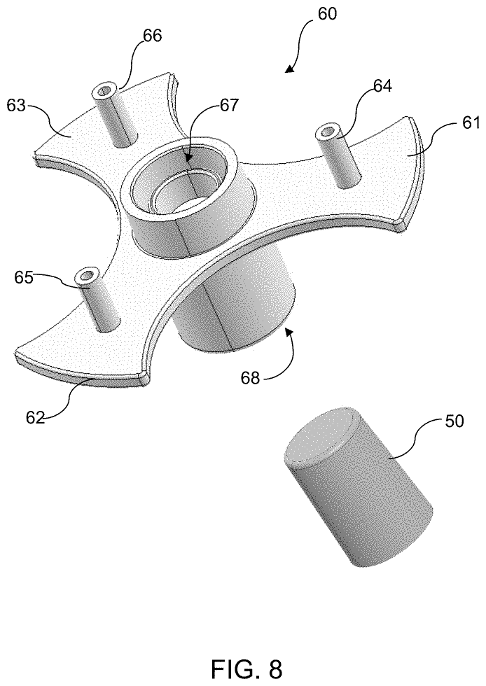

With further reference to FIG. 8, an exploded view of the central support 60 and the bearing 50 is shown. The central support structure is arranged with a plurality of fins 61, 62, 63, each having a corresponding pin 64, 65, 66. The pins are arranged to be received within a separate one of the peripheral barrels within the interior of the reamer. The support structure further includes a cylindrical center sleeve 67, arranged to receive a portion of the central barrel 45. Axially opposite the center sleeve, the support structure includes a downwardly extending annular guide 68, formed with a substantially cylindrical interior cavity. The annular guide is arranged to receive the bearing 50, thereby allowing the support structure to rotate about the central axis atop the bearing 50 and central pillar 14.

In the preferred version, the central support structure is separately formed and attached to the strainer and a cavity within the reamer portion of the strainer. In other versions, the lower portion of the reamer, or a portion of the strainer, may be molded or otherwise formed with a support surface for engaging the central pillar. Likewise, the pin and barrel arrangement may be reversed, such that the support structure is formed with barrels that surround pins formed in the interior of the reamer or lower surface of the strainer.

In use, the strainer is positioned atop the container such as illustrated in FIG. 1, with the skirt of the strainer seated within the container and the central annular guide supported by the pillar. A halved portion of a citrus fruit is positioned atop the reamer while pressing downward. The user will grasp the handle of the strainer, and may rotate the handle with respect to the downwardly-pressing fruit, preferably in a back-and-forth fashion along the arc B, or alternatively rotate the fruit against the reamer while using the handle to hold the reamer in position. The nonskid lower surface of the container maintains the container in a stationary position with respect to the horizontal surface.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims.

1. A juicer, comprising:
a container having a bottom and an upwardly extending container sidewall terminating in a rim at an upper end of the container to define an interior space;
a central pillar extending upwardly from the bottom of the container and defining a central axis of the container;
a strainer removably attached to the central pillar, the strainer having a reamer surrounded by a plurality of through-holes and a peripheral upwardly-extending strainer sidewall, the strainer further having a handle extending radially outwardly from the strainer sidewall and radially beyond the container sidewall when the strainer is attached to the central pillar;
the strainer being rotatable with respect to the container, via movement of the handle, about the central axis.

2. The juicer of claim 1, wherein the central pillar is integrally formed with the container.

3. The juicer of claim 2, further comprising an internal shoulder positioned on an internal surface of the container sidewall, the internal shoulder at least partially supporting the strainer.

4. The juicer of claim 3, wherein the strainer further comprises a lower skirt extending downwardly away from the strainer sidewall, the strainer skirt at least partially supported by the internal shoulder.

5. The juicer of claim 3, wherein the reamer is integrally formed with the strainer.

6. The juicer of claim 1, wherein the lower skirt is radially inward of the strainer sidewall to define a lower abutment, the lower abutment at least partially supported by the rim of the container.

7. The juicer of claim 6, further comprising a central support positioned within an interior cavity of the reamer, the central support being coupled to the central pillar.

8. (canceled)

9. A juicer, comprising:
a container having a bottom and an upwardly extending container sidewall terminating in a rim at an upper end of the container to define an interior space, the container defining a central axis extending from the bottom through a center of a perimeter defined by the rim;
a central pillar extending upwardly from the container along the central axis;
a strainer having a reamer surrounded by a plurality of through-holes and a peripheral upwardly-extending strainer sidewall, the strainer further having a handle extending radially outwardly beyond the strainer sidewall;
the strainer being removably attachable to the container, wherein when the strainer is attached to the container it is supported by the rim and coupled to the central pillar, the handle extends radially beyond the container sidewall, and the strainer is rotatable with respect to the container, via movement of the handle, about the central axis.

10. The juicer of claim 9, wherein the central pillar is integrally formed with the container.

11. The juicer of claim 10, further comprising an internal shoulder positioned on an internal surface of the container sidewall, the internal shoulder at least partially supporting the strainer.

12. The juicer of claim 11, wherein the strainer further comprises a lower skirt extending downwardly away from the strainer sidewall, the strainer skirt at least partially supported by the internal shoulder.

13. The juicer of claim 12, wherein the reamer is integrally formed with the strainer.

14. The juicer of claim 13, wherein the lower skirt is radially inward of the strainer sidewall to define a lower abutment, the lower abutment at least partially supported by the rim of the container.

15. The juicer of claim 13, further comprising a central support positioned within an interior cavity of the reamer, the central support being coupled to the central pillar.
